(19) United States
(12) Patent Application Publication
(10) Pub. No.: US 2015/0136442 A1
(43) Pub. Date: May 21, 2015

(54) Booster Cable for Motor Vehicle

(71) Applicant: ShangHai Guangwei Electric & Tools Co., Ltd

(72) Inventors: Di Yu, Shanghai (CN); Qian Shi, Shanghai (CN); Jianbo Wang, Shanghai (CN); Yeping Fan, Shanghai (CN)

(73) Assignee: ShangHai Guangwei Electric & Tools Co., Ltd

(21) Appl. No.: 14/547,061

(22) Filed: Nov. 18, 2014

(30) Foreign Application Priority Data
Nov. 18, 2013 (CN) 201320729037.9

(51) Int. Cl. H01B 7/36; H01B 7/00

(52) U.S. Cl. CPC H01B 7/361; H01B 7/0063
USPC 174/113 R; 174/110 R

(57) ABSTRACT

A new booster cable for motor vehicle includes a first cable body. The first cable body includes a first insulation and a first conductor located inside the first insulation. A first temperature warning color strip is embedded on the first insulation. The first temperature warning color strip contacts with the first conductor. The booster cable further includes a second cable body. The second cable body includes a second insulation and a second conductor located inside the second insulation. The first cable body and the second cable body are connected in parallel. By adopting the temperature warning color strip, the booster cable of the present invention solves the problem of faster aging of booster cable for motor vehicle due to temperature rise during use and at the same times, it warns the user to keep naked hands away from electric wires before it returns to the normal temperature completely.

### CROSS REFERENCE OF RELATED APPLICATION

The present invention claims priority under 35 U.S.C. 119(a-d) to CN 201320729037.9, filed Nov. 18, 2013.

### BACKGROUND OF THE PRESENT INVENTION

1. Field of Invention

The present invention relates to a battery cable in the technical field of automotive accessories. More specifically, it relates to a new booster cable for motor vehicle.

2. Description of Related Arts

The current booster cable for motor vehicle experiences faster aging and even short circuiting due to wire temperature rise resulting from high current after a motor vehicle ignites many times. At the same time, as the temperature exceeds that can be endured by human body, it causes a scalding harm.

None of existing technologies have any design or device that can show clearly the temperature changes during the use of booster cable for motor vehicle.

### SUMMARY OF THE PRESENT INVENTION

In consideration of the above insufficiency in the existing technologies, the present invention provides a new booster cable for motor vehicle.

The present invention is achieved through the following technical proposal.

A booster cable for motor vehicle comprises a first cable body which comprises a first insulation and a first conductor located inside the first insulation, wherein a first temperature warning color strip is embedded on the first insulation and the first temperature warning color strip contacts with the first insulation.

Preferably, the first temperature warning color strip is formed with the first insulation integrally.

Preferably, the first temperature warning color strip is made of a temperature-sensing and color-changing material having a performance that a color changes with temperature or illumination.

Preferably, the booster cable for motor vehicle further comprises a second cable body which comprises a second insulation and a second conductor located inside the second insulation, wherein the first cable body and the second cable body is connected in parallel.

Preferably, the first cable body and the second cable body is connected in parallel through a linking part.

Preferably, the second insulation has a second temperature warning color strip provided at least partially and the second temperature warning color strip contacts with the second conductor.

Preferably, the second temperature warning color strip is formed integrally with the second insulation.

Preferably, the second temperature warning color strip is made of a temperature-sensing and color-changing material having a performance that a color changes with temperature or illumination.

Preferably, the first temperature warning color strip axially penetrates through a naked part of the first insulation and the second temperature warning color strip axially penetrates through a naked part of the second insulation.

Compared with the existing technologies, the present invention has the following beneficial effects:
1. An existing temperature-sensing and color-changing material, as the temperature warning color strip, is used to show whether the temperature of the product is high for avoiding harm to human body;
2. The embedded color strip directly contacts with the conductor, so the cable temperature condition can be sensed in a fastest manner;
3. The use of a cable formed by once-for-all injection molding with a mold avoids the problem of easy stripping in the second strip injection and at the same time, there is no cost increase due to injection molding for the second time in the production process.

In the booster cable for motor vehicle provided by the present invention, the temperature warning color strip is adopted to solve the problem of faster product aging due to wire temperature rise during use and at the same time, it warns the user to keep the naked hands away from wire before it returns to the normal temperature completely.

### BRIEF DESCRIPTION OF THE DRAWINGS

Through reading and referring to the detailed description about the non-limited embodiment examples in the figures attached below, the other characteristics, purposes and advantages of the present invention will become more apparent:

FIG. 1 is a cross section for a booster cable for motor vehicle provided by the present invention.

FIG. 2 is a 3-dimensional diagram for the 1^{st} cable body.

FIG. 3 is a 3-dimensional diagram for a parallel cable of the 1^{st} cable body and the 2^{nd} cable body.

FIG. 4 is a structural schematic diagram of a processing mold for the booster cable for motor vehicle provided by the present invention.

In the drawings: 1 is insulation I, 2 is temperature warning color strip I, 3 is parallel cable linking part, 41 is conductor I, 42 is conductor II, 5 is insulation II, 6 is feed port, 7 is conductor passing hole, 8 is feed port for temperature warning color strip, 9 is finished cable passing hole, 10 is base cable-threading bottom mold and 11 is mold outlet.

### DETAILED DESCRIPTION OF THE PREFERRED EMBODIMENT

Now a detailed explanation is made to the embodiments of the present invention. The embodiments are embodied under the prerequisite of the technical proposal of the present invention, and give detailed embodiment ways and specific operation procedures. What should be indicated is that ordinary technicians in this field can make variations and improvements under the prerequisite being free from leaving the conception of the present invention. All these belong to the range of protection for the present invention.

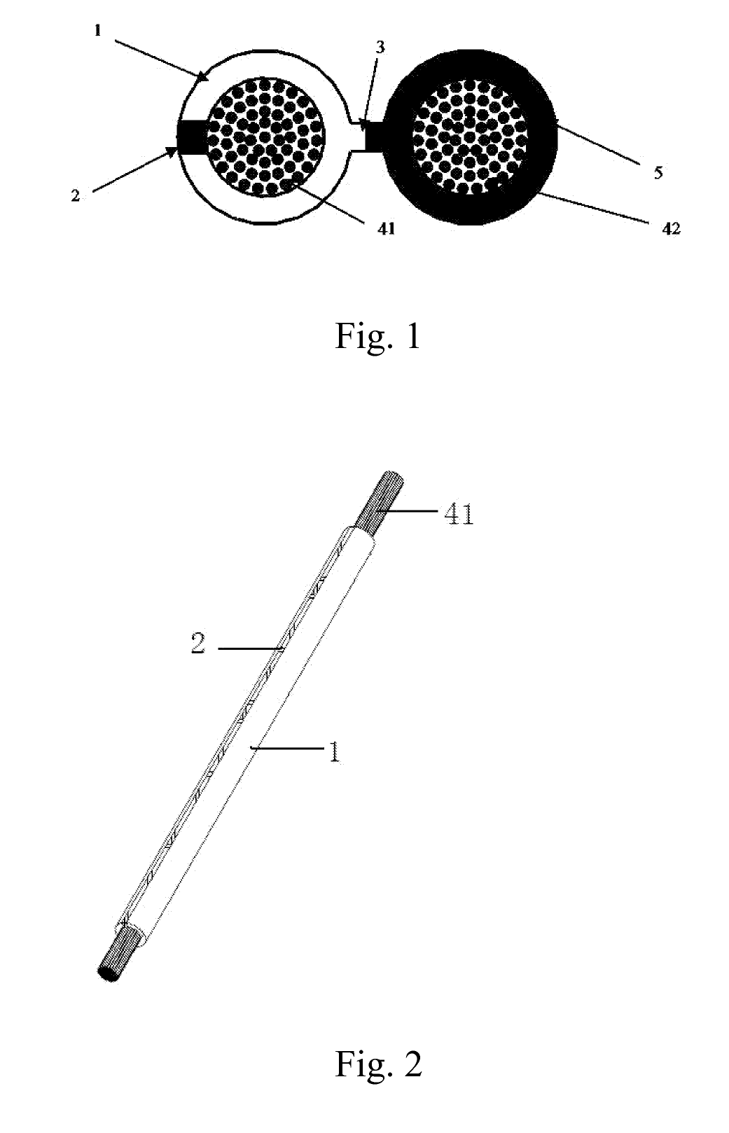

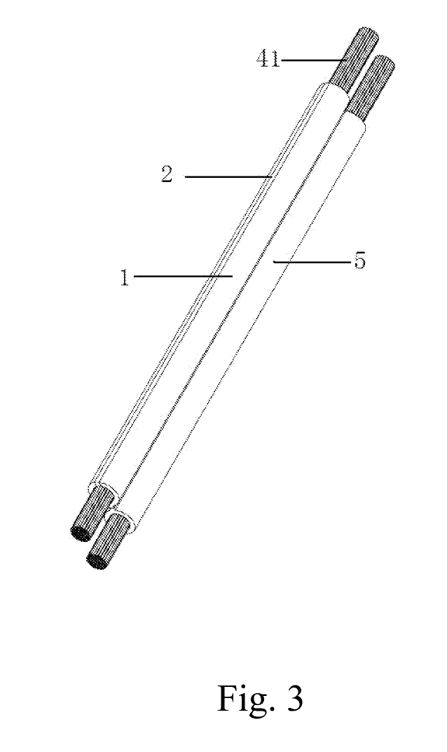

Please refer to FIGS. 1 to 3 simultaneously.

### Embodiment 1

This embodiment provides a new booster cable for motor vehicle, including a 1^{st} cable body. The 1^{st} cable body includes an insulation I1 and a conductor I41 located inside the insulation I1. On the insulation I1, a temperature warning color strip I2 is embedded. The temperature warning color strip 2 contacts with the conductor I41.

Further, the temperature warning color strip I2 is formed with the insulation I1 integrally.

Further, the temperature warning color strip I2 is made of a temperature-sensing and color-changing material having a performance that the color changes with temperature and illumination.

### Embodiment 2

Based on the embodiment 1, this embodiment also includes a 2^{nd} cable body. The 2^{nd} cable body includes an insulation II5 and a conductor II42 located inside the insulation II5. The 1^{st} cable body and the 2^{nd} cable body are connected in parallel.

Further, the 1^{st} cable body and the 2^{nd} cable body are connected in parallel through a parallel cable linking part 3.

Further, the insulation II5 has a temperature warning color strip II at least partially provided. The temperature warning color strip II contacts with the conductor II42.

Further, the temperature warning color strip II is formed integrally with the insulation II5.

Further, the temperature warning color strip II is made of a temperature-sensing and color-changing material having a performance that the color changes with temperature and illumination.

Further, the temperature warning color strip I2 axially penetrates through a naked part of the insulation I1, and/or the temperature warning color strip II axially penetrates through a naked part of the insulation II5.

The above two embodiments are specifically as follows.

The booster cable for motor vehicle as provided in the embodiments has a temperature warning color strip added to the 1^{st} cable body, which can change its color with temperature or illumination. During service, the temperature warning color strip gives a warning as the wire temperature rises and at the same time, reminds the users to keep their naked hands away from the electric wire before it returns to the normal temperature.

For the booster cable for motor vehicle as provided in the embodiments, the three-color embedded injection molding method is adopted in process.

The three-color embedded injection molding method is realized through the three-color embedded injection molding mold specifically.

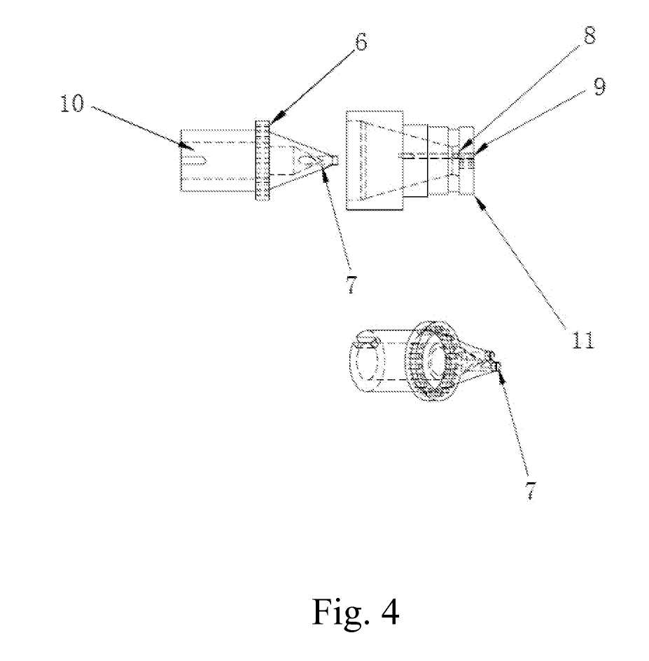

As shown in FIG. 4, the three-color embedded injection molding mold includes a base cable-threading bottom mold and a mold outlet. The base cable-threading bottom mold can be inserted into a mold cavity of the mold outlet from a 1^{st} end of the mold outlet; and a feed port is provided on an outer circumference of the base cable-threading bottom mold. A conductor passing hole is provided at an insertion end of the base cable-threading mold; a feed port for temperature warning color strip provided axially and a finished cable passing hole are provided at a 2^{nd} end of the mold outlet. When the base cable-threading bottom mold is inserted into the mold outlet, the conductor passing hole is close to the finished cable passing hole.

While working, the insulation I and the temperature warning color strip of the 1^{st} cable body enter into the mold cavity through the small hole of the feed port respectively. The feed port of the temperature warning color strip is adapted for feeding for color adjustment, the material enters into different regions through diversion to make qualified products.

The 2^{nd} cable body has the same manufacturing process as the 1^{st} cable body, so no details are described herein.

The embodiments of the present invention are described above. What should be understood is that the present invention is not limited to the above specific embodiments. Technicians in this field can make various variations or modifications within the range of claims and this will not influence the substantial contents of the present invention.

What is claimed is:

1. A booster cable for motor vehicle comprising a first cable body which comprises a first insulation and a first conductor located inside the first insulation, wherein a first temperature warning color strip is embedded on the first insulation and the first temperature warning color strip contacts with the first insulation.

2. The booster cable for motor vehicle, as recited in claim 1, wherein the first temperature warning color strip is formed with the first insulation integrally.

3. The booster cable for motor vehicle, as recited in claim 1, wherein the first temperature warning color strip is made of a temperature-sensing and color-changing material having a performance that a color changes with temperature or illumination.

4. The booster cable for motor vehicle, as recited in claim 1, further comprising a second cable body which comprises a second insulation and a second conductor located inside the second insulation, wherein the first cable body and the second cable body is connected in parallel.

5. The booster cable for motor vehicle, as recited in claim 2, further comprising a second cable body which comprises a second insulation and a second conductor located inside the second insulation, wherein the first cable body and the second cable body is connected in parallel.

6. The booster cable for motor vehicle, as recited in claim 3, further comprising a second cable body which comprises a second insulation and a second conductor located inside the second insulation, wherein the first cable body and the second cable body is connected in parallel.

7. The booster cable for motor vehicle, as recited in claim 4, wherein the first cable body and the second cable body is connected in parallel through a linking part.

8. The booster cable for motor vehicle, as recited in claim 5, wherein the first cable body and the second cable body is connected in parallel through a linking part.

9. The booster cable for motor vehicle, as recited in claim 6, wherein the first cable body and the second cable body is connected in parallel through a linking part.

10. The booster cable for motor vehicle, as recited in claim 4, wherein the second insulation has a second temperature warning color strip provided at least partially and the second temperature warning color strip contacts with the second conductor.

11. The booster cable for motor vehicle, as recited in claim 5, wherein the second insulation has a second temperature warning color strip provided at least partially and the second temperature warning color strip contacts with the second conductor.

12. The booster cable for motor vehicle, as recited in claim 6, wherein the second insulation has a second temperature warning color strip provided at least partially and the second temperature warning color strip contacts with the second conductor.

13. The booster cable for motor vehicle, as recited in claim 10, wherein the second temperature warning color strip is formed integrally with the second insulation.

14. The booster cable for motor vehicle, as recited in claim 11, wherein the second temperature warning color strip is formed integrally with the second insulation.

15. The booster cable for motor vehicle, as recited in claim 12, wherein the second temperature warning color strip is formed integrally with the second insulation.

16. The booster cable for motor vehicle, as recited in claim 10, wherein the second temperature warning color strip is made of a temperature-sensing and color-changing material having a performance that a color changes with temperature or illumination.

17. The booster cable for motor vehicle, as recited in claim 12, wherein the second temperature warning color strip is made of a temperature-sensing and color-changing material having a performance that a color changes with temperature or illumination.

18. The booster cable for motor vehicle, as recited in claim 10, wherein the first temperature warning color strip axially penetrates through a naked part of the first insulation and the second temperature warning color strip axially penetrates through a naked part of the second insulation.

19. The booster cable for motor vehicle, as recited in claim 11, wherein the first temperature warning color strip axially penetrates through a naked part of the first insulation and the second temperature warning color strip axially penetrates through a naked part of the second insulation.

20. The booster cable for motor vehicle, as recited in claim 12, wherein the first temperature warning color strip axially penetrates through a naked part of the first insulation and the second temperature warning color strip axially penetrates through a naked part of the second insulation.
